(19) United States
(12) Patent Application Publication
(10) Pub. No.: US 2004/0251275 A1
(43) Pub. Date: Dec. 16, 2004

(54) Mixing and dispensing device comprising multiple pressurized containers

(76) Inventors: Stephen Sams, London (GB); David Aubrey Plumptre, Droitwich (GB); Steven Wimpenny, Leamington Spa (GB)

Correspondence Address: THE PROCTER & GAMBLE COMPANY, INTELLECTUAL PROPERTY DIVISION, WINTON HILL TECHNICAL CENTER - BOX 161, 6110 CENTER HILL AVENUE, CINCINNATI, OH, 45224, US

(21) Appl. No.: 10/729,602

(22) Filed: Dec. 5, 2003

(30) Foreign Application Priority Data
Dec. 6, 2002 (EP) 02258439.5

(51) Int. Cl. B67D 5/60

(52) U.S. Cl. 222/145.6; 222/402.1

(57) ABSTRACT

A dispensing device (10) comprising a first (20) and second (30) pressurized containers, each fitted with a valve (40, 50) and respectively comprising a first and second compositions. The valve (40) of the first container and the valve of the second container are facing each other. The device comprises actuator means (70) for actuating the valves to allow the expulsion of said first and second compositions from their respective containers into a flow pathway (260, 270, 280). The flow pathway comprises mixing means (270) for mixing said first and second compositions into a mixed composition. The mixed composition is dispensed onto the surface to be treated via dispensing means (290) which may comprise an applicator (310, 320).

### BACKGROUND OF THE INVENTION

Many products are obtained by mixing two or more compositions immediately before use. These compositions may react physically and/or chemically and are typically stored and sold in different containers as they may lose quickly their independent functionality once mixed. For example, commercial permanent hair dyes usually comprise two separately packaged compositions, respectively an oxidative dye composition (comprising oxidative hair dye precursors and typically an alkalinizing agent) and an oxidizing composition (comprising an oxidizing agent, usually hydrogen peroxide).

Oxidative hair dye precursors are molecules small enough to migrate into the hair shaft where they react in-situ with the oxidizing agent to form larger molecules that color the hair. The dye molecules formed are larger than the precursors and cannot escape from the hair shaft, providing a “permanent” hair dye. These permanent hair dyes provide excellent results in terms of quality of the color but one major drawback is that the dye composition and the oxidizing composition are highly reactive with each other and thus are not typically stored or sold in the same container. This is because the permanent dye molecules that would form inside the container would be too large to migrate inside the hair shaft. This is a main reason why permanent hair dyes are usually sold in packages comprising at least two separately packaged compositions that are to be mixed prior to use.

Other products are sold as dual or multi-packaged compositions that are mixed immediately before use. Examples of such other products are adhesives, particularly epoxies, and paints. The Applicants envision that this device may also be used for deodorant products.

Devices comprising multiple pressurized containers for mixing and delivering a mixed product have been proposed in the art. However the previously proposed systems have a number of failings.

Many systems require multiple operations to activate both containers. For example in EP129823, EP63759 and JP94199368, one container must be activated into the second container, the contents of both containers are mixed and then dispensed from the second container.

Other art, for example EP0510352 and EP0062817, teaches the practice of placing one pressurized container within the other, which increases the possibility of product reaction to the container materials, which is undesireable.

Other examples of art fail ergonomically due to the orientation of the multiple pressurized containers.

JP 1999-198,975 and EP245,172 disclose dual pressurized devices wherein two pressurized containers are aligned side-by-side with the valves of the containers facing the same direction (i.e. up). However, this arrangement provides a wide mass to be grasped in a single hand of a consumer, and consumers not having large hands may find this difficult. Further, where two non-identical compositions contained in the separate containers need to be mixed upon actuation, adequate mixing will be difficult to achieve using these devices. JP 1999-198,975 simply provides a common area through which the compositions from each container pass before ultimately being dispensed from a single dispensing orifice. EP245172 specifically prevents mixing until the compositions have been dispensed from separate orifices in the device.

The art also has numerous references to combs attached to such systems. These also tend to fail ergonomically due to the position of the comb in relation to the containers. Disclosed in areas of the art, for example WO 00/10423 and JP 96168409 are references to combs mounted on top of a side-by-side orientation pressurized system. A problem associated with such art is the lack of leverage and support given to the comb from the rest of the system.

It is believed that consumers want a multi-product mixing and dispensing package that is easy to actuate, is ergonomic to use, provides precision of dispensed product and/or balances between the amount of product dispensed and the speed of dispensing.

The present invention is a mixing and dispensing device that provides one or more of the above-mentioned benefits. In particular, the present invention is easy to handle and to actuate and is designed for people to interact with safely, effectively, and pleasantly. The device can be used for mixing and delivering various types of compositions, and is especially suited for delivering hair dye compositions.

### SUMMARY OF THE INVENTION

This invention relates to a mixing and dispensing device comprising a first and second pressurized containers, respectively comprising a first composition and a second composition to be delivered as a mixture. The first and second containers are each fitted with a valve and the containers are orientated such that these valves are positioned facing each other (“end-on-end” orientation). Actuator means are provided for actuating the valves to allow the expulsion of said first and second compositions from their respective containers into a flow pathway. The flow pathway comprises mixing means for mixing said first and second compositions into a mixed composition. The mixed composition is dispensed onto the surface to be treated via dispensing means that may comprise an applicator.

The pressurized containers may be held in place by a body component, which may comprise the actuator means.

In a preferred embodiment, the device has a substantially elongated shape with the first container on one end and the second container on the other end. In this preferred embodiment, the first container may be used as a handle and the second container may be used as a support for attaching a specialized applicator. If the mixed composition is applied to the hair (e.g. hair dye), the applicator has preferably the shape of a comb/brush.

### BRIEF DESCRIPTION OF THE DRAWINGS

The drawings provided herein are meant to be illustrative, not restrictive, of the invention.

FIG. 1 is a side view of an embodiment of a dispensing device according to the invention wherein the actuation means is a toggle system.

FIG. 2 is a partial front sectional view of the device of FIG. 1 showing the elements of the body component. The dotted lines represent the position of the toggle system when actuated.

FIG. 3 is a partial side sectional view of the device of FIG. 1.

FIG. 4 is an exploded view of the device of FIG. 1.

FIG. 5 is an exploded view of a device according to FIG. 1 wherein the actuation means is a double wedge system.

FIG. 6 is an exploded view of a dispensing device according to FIG.1 wherein the actuation means is a cam system.

FIG. 7 is a close-up perspective view of the cam system shown in FIG. 6.

### DETAILED DESCRIPTION OF TIRE INVENTION

Throughout this description, a consumer may be any person who dispenses the mixed product from the dispensing device described herein. Some non-limiting examples: (a) in the case of a person who makes a personal use of the device, for example for coloring their own hair at home, the consumer is that person; (b) in the case of a person who goes to a salon or elsewhere to have a cosmetic product applied to their body by a beauty-care specialist, for example hair coloring by a hair care professional, that beauty-care specialist is the consumer; and (c) in the case of a person who dispenses a mixed product onto the coat of a pet or other animal, the consumer is that person.

Except as otherwise noted, all amounts including quantities, percentages, portions, and proportions, are understood to be modified by the word “about”, and amounts are not intended to indicate significant digits. Except as otherwise noted, the articles “a”, “an”, and “the”, mean “one or more”. All documents cited are, in relevant part, incorporated herein by reference; the citation of any document is not to be construed as an admission that it is prior art with respect to the present invention.

Essential and optional elements of the devices according to the present invention will now be described in detail by reference to various exemplary embodiments of the invention, several of which are also illustrated herein, wherein like numerals indicate the same elements throughout the description.

Containers—Valves—Body Component

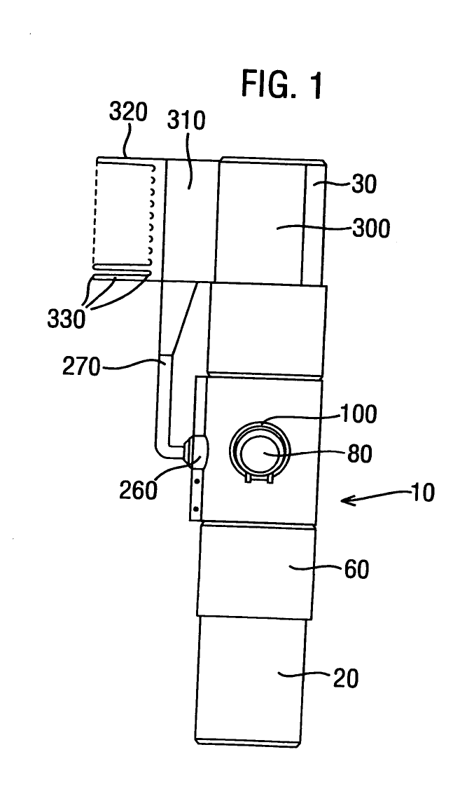

As shown in FIGS. 1-3, a mixing and dispensing device 10 according to the present invention comprises two pressurized containers 20 and 30 respectively fitted with valves 40 and 50. The containers may be held in position by a body component 60. Pressurized containers 20 and 30 and body component 60 should be dimensioned to fit each other. As shown in FIGS. 1-3, the pressurized containers may typically have a cylindrical shape, although other shapes may be considered.

The containers 20 and 30 respectively contain the first and second compositions. It is unimportant which is designated as a first composition and which is designated as a second composition. The first and second compositions are non-identical. In addition to compositions that exhibit easily apparent formula differences, non-identical compositions may only differ in relation to their concentration, color, scent, viscosity, temperature, the pressure they are stored at, or other physical or chemical characteristics. The first and second compositions may upon or after mixing react physically or chemically or both. The mixed composition resulting from the mixing of the first and second compositions may be dispensed in any suitable form, for example aerosol, mousse, cream or foam. The containers 20 and 30 contain a propellant. The propellant may be any component suitable for expelling the contents of the containers upon actuation. Such propellants include but are not limited to compressed gas, compressed air, liquid petroleum gasses (e.g. butane and propane), and where appropriate, mixtures thereof.

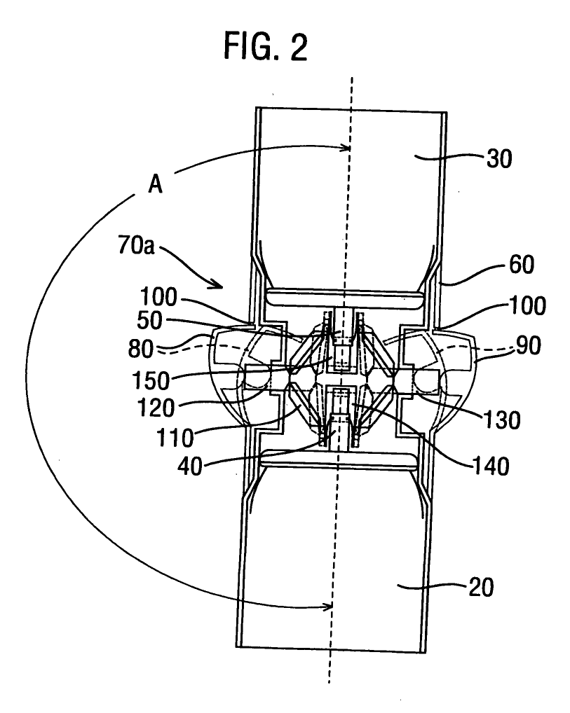

Pressurized containers 20 and 30 further comprise valves 40 and 50, respectively, as shown in FIG. 2. Pressurized containers 20 and 30 are oriented such that valves 40 and 50 are facing each other. Angle A is the angle measured between a line drawn axially through pressurized container 20 and a line drawn axially through pressurized container 30. Angle A is typically at least 135□, preferably at least 157□, more preferably at least 175□, more preferably 180□. The valves are preferably both central in the device allowing for a single means of actuating both containers simultaneously.

In combination with body component 60, pressurized container 20 may suitably be used as a handle for the mixing and dispensing device 10. Preferably, the first pressurized container is used as a handle and the second pressurized container is used as a support for the dispensing means, which may comprise an applicator. The nearer angle A is to 180□, the easier pressurized container 20 in combination with body component 60 may be used as a handle. Applicants have found this to be an advantage of an end-on-end orientation. Notably, for aesthetic purposes, having angle A slightly less than, but still near 180□ may be desirable. Pressurized container 20 may further be fitted with grips or may be coated to provide improved grip or hand-feel properties. Furthermore, the dispensing device is preferably substantially elongated. For example, the device may be at least twice, preferably at least twice and half, even more preferably three times as long as the average width of the first container in its non-axial direction (for example the diameter of the container if the container has a cylindrical shape) for easier handling of the device and delivery of the product. The first container is preferably capable of being used as a handle.

Actuator Means

Actuator means 70 controls the opening of the valves 40 and 50 to allow the expulsion of the first and second compositions from the pressurized containers 20 and 30. The valves are preferably actuated simultaneously by the actuator means. Non-limiting examples of actuator means include a toggle system 70a, a single or double wedge system 70b, and a cam system 70c, all of which may be used singly or where appropriate, in combination. The force applied to the actuator means may preferably be applied in a non-axial direction with respect to pressurized container 20, more preferably perpendicular to it. Selection of the actuator means may vary according to the desired “actuation feel” that the consumer should experience. For example, in a preferred embodiment using a toggle system a consumer may experience a soft, progressive, actuation feel that requires relatively little force to actuate and may comprise either a single or a dual button option. Alternatively, using a single or double wedge system a consumer may experience a firmer, more snappy actuation feel. As a further alternative, a cam device 70c could be used to provide a consumer with a sliding, rather than a pressing actuation feel, and in that case the force is applied in an axial direction.

As shown in FIG.2, the body component 60 may comprise the actuator means 70 for actuating valves 40 and 50. The actuator means may comprise two actuation buttons 80 and 90. Positioning of the actuation buttons 80 and 90 on the side of the device makes the device easy to use in combination with excellent ergonomics. Actuation of the dispensing device may be initiated by pressing both actuation buttons in parallel or individual actuation buttons by both right or left-hand users, thereby, maintaining excellent ergonomics for all users. Actuation buttons 80 and 90 may have thin transit protection tabs 100 molded into the overall body component 60 that prevents accidental actuation during transit of the dispensing device 10.

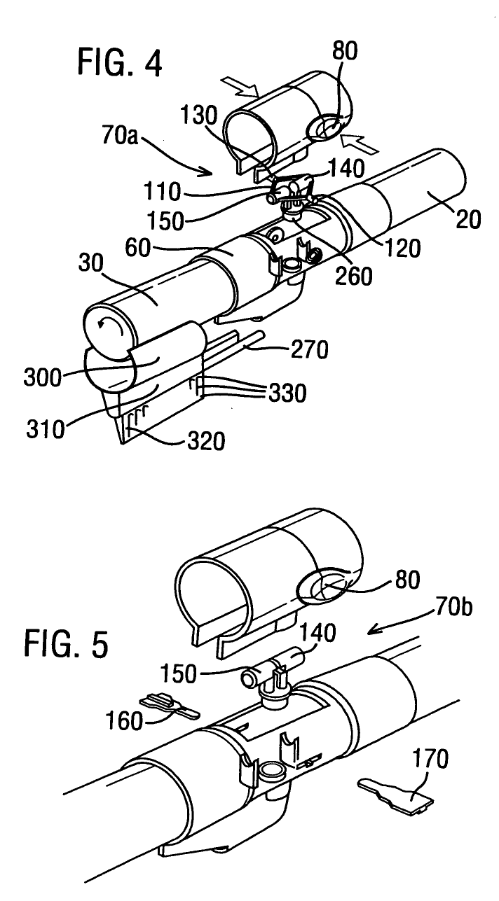

An embodiment of a toggle system 70a is illustrated in FIGS. 2 and 4. A toggle device 110 is located between each valve 40 and 50 and is held in position by the body component 60. When the consumer presses one or both the actuation buttons 80 and 90, the corresponding actuation pegs 120 and 130 are compressed and both valves 40 and 50 are opened. This action is achieved via the use of ‘live’ hinges (i.e. hinges made of flexible plastic, preferably polypropylene), molded between the two actuation pegs 120 and 130 and the two actuation stems 140 and 150 of the toggle device 110.

The toggle system provides for increased precision of dispensed product from both containers, and may help balance the amount of product dispensed and control the speed of dispensing. The toggle system allows positioning of the actuation buttons on the side of the device making the device easy to dispense in combination with excellent device ergonomics.

An alternative actuator means is a wedge system 70b, an embodiment of which is shown in FIG. 5. In this embodiment, the force applied to the actuation buttons 80 and 90 is transferred to wedges 160 and 170 that cooperate with actuation stems 140 and 150. The force drives actuation stems 140 and 150 towards valves 40 and 50 causing them to open and allow the first and second compositions to be expelled from pressurized containers 20 and 30.

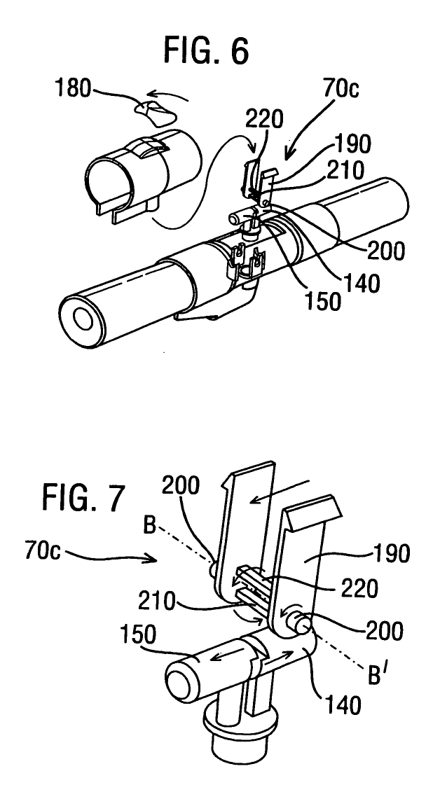

A further alternative actuator means is a cam system 70c, an embodiment of which is shown in FIGS. 6 and 7. In this embodiment, body component 60 may be provided with a slide button 180. When sufficient force is applied to slide button 180 to slide it forward (i.e. along the axis of pressurized container 20), it rotates cam actuator 190 on the hinge pegs 200. FIG. 7 shows a preferred embodiment of cam actuator 190 and actuation stems 140 and 150 in more details. The rotary movement enables a lower actuation bar 210 and an upper actuation bar 220 to move in opposite directions relative to each other, around a central pivotal point, depicted by line B-B′. Lower actuation bar 210 and upper actuation bar 220 push against actuation stems 140 and 150 forcing them apart from each other and towards valves 40 and 50 causing them to open and allow the compositions to be expelled from pressurized containers 20 and 30.

Flow Pathway

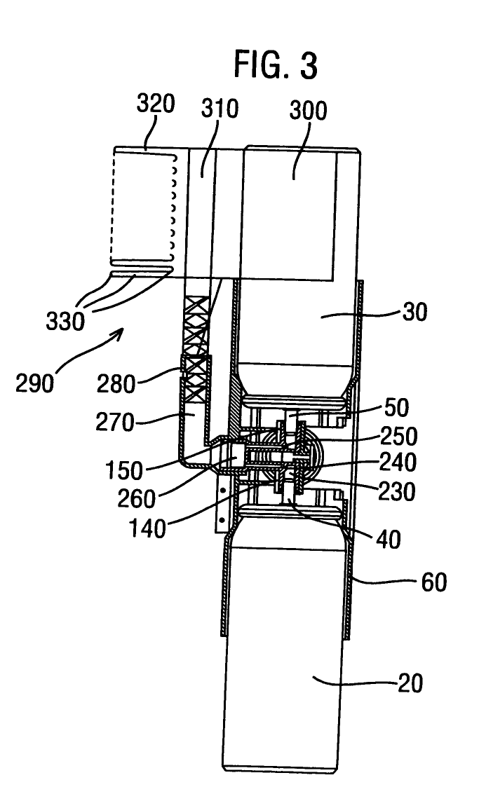

As shown in FIG. 3, once valves 40 and 50 have been opened, the first composition from pressurized container 20 and the second composition from pressurized container 30 flow past the valve non-return mechanisms located in the valve 40 and 50 into the two manifolds 230. Each manifold 230 has a restricting orifice (respectively 240 and 250) that can be adjusted by cross sectional area and/or shape to tailor the flow rates of the first and second compositions. The flow rate depends on the product characteristics or application requirement. For example a hair dye could typically have a total flow rate of between 1and 3 grams per second with a preferred flow rate being 2 grams per second. Once the first composition has passed through the restricting orifice 240 and the second composition has passed through the restricting orifice 250, the two product phases come together in a converging chamber 260. The converging compositions continue to flow into the mixing chamber 270 that preferably contains a static mixer 280 sufficient to provide mixing of the first and second compositions. Static mixers themselves are known in the art and may be, for example of the helical, sinusoidal or spiral type. An example of helical mixer is disclosed in U.S. Pat. No. 4,850,705. Any other suitable mixing means can be used for mixing the first and second compositions.

Use of a static mixer in the system may enable the mixed product to reach the dispensing orifice(s) (which may comprise a comb applicator as in FIG. 1) more thoroughly mixed and ready for direct application. The mixing chamber and mixing means may be dimensioned to provide for mixing ratios as desired.

Dispensing Means

The device further comprises dispensing means 290 for dispensing the mixed composition on a substrate. The dispensing means is in fluid communication with the flow pathway and preferably comprises an applicator specially designed to facilitate the application of a specific composition to a specific type of substrate. For example the applicator may be a nozzle, a spout, or a comb. The applicator is preferably positioned along the side of pressurized container 30 i.e. on the end of the device opposite to the pressurized container 20 which may be used as a handle.

For the application of hair care products such as hair dyes, the applicator will preferably be a comb, as shown on FIG. 1, 2 and 4. As shown in FIG. 4, the comb-applicator comprises a sliding clip component 300 that slides over pressurized container 30 and snaps into the body component 60 at the end of the mixing chamber 270. The sliding clip component 300 also contains the comb housing manifold 310. The comb tine 320 is connected to the comb housing manifold 310. The combination of the sliding clip component 300 snapped into the body component 60, the comb housing manifold 310 and the comb tine 320 provides a comb or brush applicator.

As shown in FIG. 3 the mixed product flows from the mixing chamber 270 and static mixer 280 into the comb housing manifold 310 and the comb tine 320. The mixed product is then applied through a number of dispensing orifices 330 located within the comb tine 320. The comb may optionally comprise different types and/or arrangements of tines. Particularly useful comb and tine arrangements are those described in international application WO02/58505, assigned to The Procter & Gamble Company.

By orienting pressurized containers 20 and 30 such that valves 40 and 50 are facing each other, when pressurized container 20 is used as a handle and pressurized container 30 further comprises a comb applicator attached to it, a dispensing device 10 is provided that resembles a typical comb or brush, which enables comfortable and intuitive use by a consumer. This is particularly true when the mixed composition being dispensed is a hair care composition, preferably a hair colorant composition. Simulating a conventional comb or brush is important in providing a dispensing device that is ergonomically superior to those available in the art. Furthermore, because dispensing devices 10 according to the present invention may be easily interchanged between one hand and the other of a consumer they may suitably be used by either right or left-handed consumers.

Method of Making

The device described here may be made using conventional means. Conventional canisters used in the aerosol industry may be used for the pressurized containers. The other parts of the device may be manufactured in conventional material by conventional means, for example plastic pieces obtained by injection molding.

Method of Use

The device may be used to deliver a mixed composition to a variety of substrate. Hair care products such as hair dyes may be intuitively and easily delivered, especially when the device comprises an applicator in the form of a comb.

Notice

All documents cited in the Detailed Description of the Invention are, in relevant part, incorporated herein by reference; the citation of any document is not be construed as an admission that it is prior art with respect to the present invention.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A mixing and dispensing device comprising:
(a) a first pressurized container having a first valve and containing a first composition;
(b) a second pressurized container having a second valve and containing a second composition,
(c) actuator means for actuating the valves to allow the expulsion of said first and second compositions from their respective containers into a flow pathway comprising mixing means for mixing said first and second compositions into a mixed product; and
(d) dispensing means for dispensing said mixed product, said dispensing means being in fluid communication with said flow pathway;
wherein said first valve and second valve are positioned facing each other.

2. A dispensing device according to claim 1 wherein said first and second pressurized containers are held in position by a body component.

3. A dispensing device according to claim 1 wherein said mixing means comprises a mixing chamber.

4. A dispensing device according to claim 3 wherein said mixing chamber comprises a static mixer.

5. A device according claim 1 wherein the actuator means is selected from the group consisting of a toggle system, a double wedge system and a cam system.

6. A device according to claim 5 wherein the actuator means is a toggle system.

7. A device according to claim 1 wherein said applicator device is substantially elongated and comprises a first end and a second end.

8. A device according to claim 7 wherein said first container forms said first end and said second container forms said second end.

9. A device according to claim 7 wherein said first end can be used as a handle and wherein said dispensing means is attached to said second end.

10. A device according to claim 1 wherein said dispensing means comprises an applicator selected from the group consisting of nozzle, tube, spout and comb.

11. A device according to claim 1 wherein the angle A measured between a line drawn axially through pressurized container 20 and a line drawn axially through pressurized container 30 is at least 135°.

12. A device according to claim 11 wherein the angle A is at least 157°.

13. A device according to claim 12 wherein the angle A is at least 175°.

14. A device according to claim 1 wherein said mixed composition is in a form selected from the group consisting of aerosol, mousse, cream and foam.

15. A device according to claim 14 wherein the mixed composition is in the form of an aerosol.

16. A dispensing device according to claim 1 wherein said mixed composition is an oxidative hair dye composition.

17. A method of applying a mixed composition to a substrate, said method comprising the steps of:
(a) providing a device according to claim 1,
(b) actuating the actuator means to expel the first and second compositions into the mixing chamber to form a mixed composition; and
(c) dispensing the mixed composition on to the substrate.

18. A method according to claim 17 wherein said mixed composition is an oxidative hair dye composition and said substrate is hair.
